(19) United States
(12) Patent Application Publication
(10) Pub. No.: US 2012/0225415 A1
(43) Pub. Date: Sep. 6, 2012

(54) LEARNING CONTENT DELIVERY SYSTEM

(75) Inventors: Christopher Michael Vento, Manchester, MA (US); Prashant Varadraj Nayak, South Grafton, MA (US); Robert James Dumas, Stratham, NH (US)

(73) Assignee: CENGAGE LEARNING, INC., Stamford, CT (US)

(21) Appl. No.: 13/411,158

(22) Filed: Mar. 2, 2012

Related U.S. Application Data
(60) Provisional application No. 61/448,258, filed on Mar. 2, 2011.

(51) Int. Cl. G09B 3/00

(52) U.S. Cl. 434/350

(57) ABSTRACT

A learning content delivery system is provided that includes a network, a plurality of remotely stored content delivery applications each having learning content, one or more user devices, and a platform. The platform has an application framework that allows the one or more user devices to access the remotely stored applications and learning content via the network. The applications can include at least two platform specific applications, which are developed on a common application programming interface. The platform can dynamically sense one or more attributes of each user device and to customize presentation of the learning content from the platform specific applications for the user device. The application framework can provide two-way awareness between the platform and the platform specific applications.

### CROSS REFERENCE TO RELATED APPLICATIONS

This application claims the benefit of U.S. Provisional Application Ser. No. 61/448,258, which was filed on Mar. 2, 2011, the contents of which are incorporated by reference herein.

### BACKGROUND OF THE INVENTION

1. Field of the Invention

The present disclosure is related to distance or on-line learning. More particularly, the present disclosure is related to a flexible system configured to deliver learning content from a number of different content sources to a number of different types of user devices (e.g., desktops, laptops, tablets, and mobile phones).

2. Description of Related Art

The Internet is a conduit through which various types of media content (e.g., news, entertainment, etc) is provided to users. For example, the Internet is currently being used to deliver content, such as educational or learning content, to users.

Unfortunately, the learning content that is available via the Internet is provided in many different formats (e.g., video, textual, interactive, etc), which has made it difficult to provide a user with common access to the available content.

Accordingly, it has been determined by the present disclosure that there is there is a need for flexible content delivery platforms that deliver learning content in a manner that overcomes, alleviates, and/or mitigates one or more of the aforementioned and other deleterious effects of the prior art.

### BRIEF SUMMARY OF THE INVENTION

A learning content delivery system is provided that includes a network, a plurality of remotely stored content delivery applications each having learning content, one or more user devices, and a platform. The platform has an application framework that allows the one or more user devices to access the remotely stored applications and learning content via the network.

The one or more user devices can be a desktop computer, a laptop computer, a personal digital assistants, a tablet computer, a smart phone, a mobile phone, and any combinations thereof. The communication between the one or more user devices and the network is wired communication, wireless communication, or any combination thereof.

In some embodiments, the applications include at least two platform specific applications, which are developed on a common application programming interface. In other embodiments, the platform is configured to dynamically sense one or more attributes of each user device and to customize presentation of the learning content from the platform specific applications for the user device.

The application framework is configured to provide two-way awareness between the platform and the platform specific applications.

A method of delivering learning content is also provided that includes providing a plurality of learning content delivery applications; organizing a learning path made up of a plurality of discrete learning units, each learning unit comprising a plurality of learning activities, wherein each learning activity is defined by learning content available from a different one of the plurality of content delivery applications; and delivering, via a network, the learning content to a user device in an order defined by the learning units and learning path.

In some embodiments, the method includes dynamically sensing one or more attributes of the user device and automatically customizing presentation of the learning content from the platform specific applications for the user device. In other embodiments, the method includes providing two-way awareness between the at least two platform specific applications.

In some embodiments, a learning content delivery system is provided that includes a network, a user device in communication with the network, a plurality of remotely stored learning activity applications, each of the plurality of learning activity applications comprising learning content, a measurement application residing on a server, and a platform, residing on the server. The platform has an application framework that allows the user device to access the plurality of learning activity applications and learning content via the network. The application framework provides awareness among the platform, the plurality of learning activity applications, and the measurement application so that the measurement application measures one or more attributes of a user's interaction with the plurality of learning activity applications and the learning content. The platform adjusts a learning path through the plurality of remotely stored learning activity applications based on the one or more attributes.

The above-described and other features and advantages of the present disclosure will be appreciated and understood by those skilled in the art from the following detailed description, drawings, and appended claims.

### BRIEF DESCRIPTION OF THE SEVERAL VIEWS OF THE DRAWINGS

FIGS. 1 and 2 are schematic depictions of an exemplary embodiment of an architecture of a learning content delivery system according to the present disclosure; and

FIG. 3 is a schematic depiction of an exemplary embodiment of a learning content delivery platform according to the present disclosure.

### DETAILED DESCRIPTION OF THE INVENTION

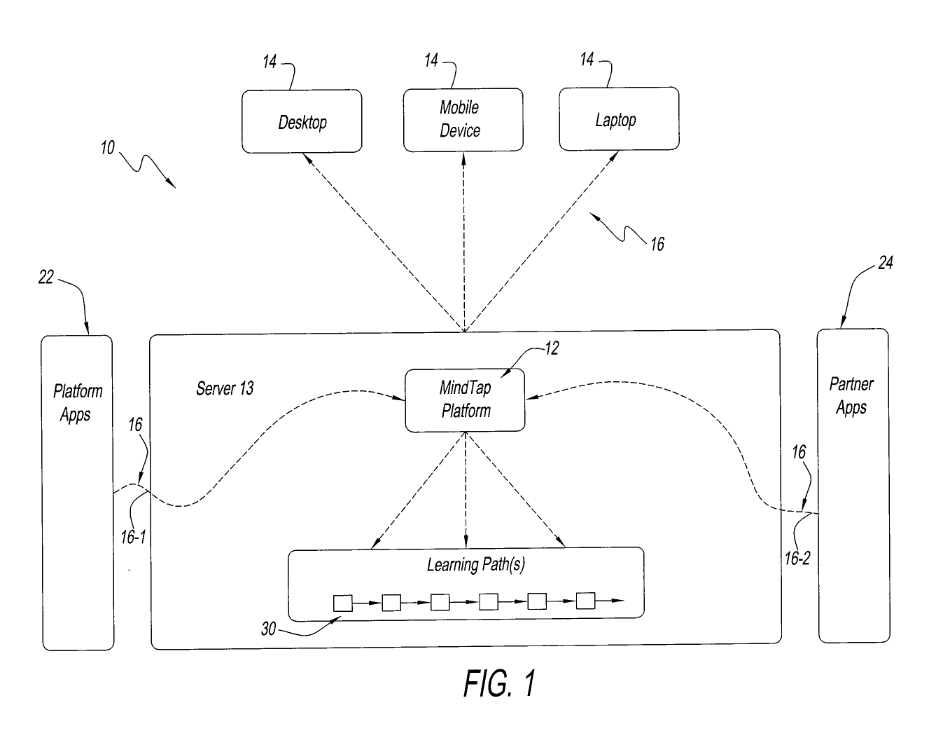

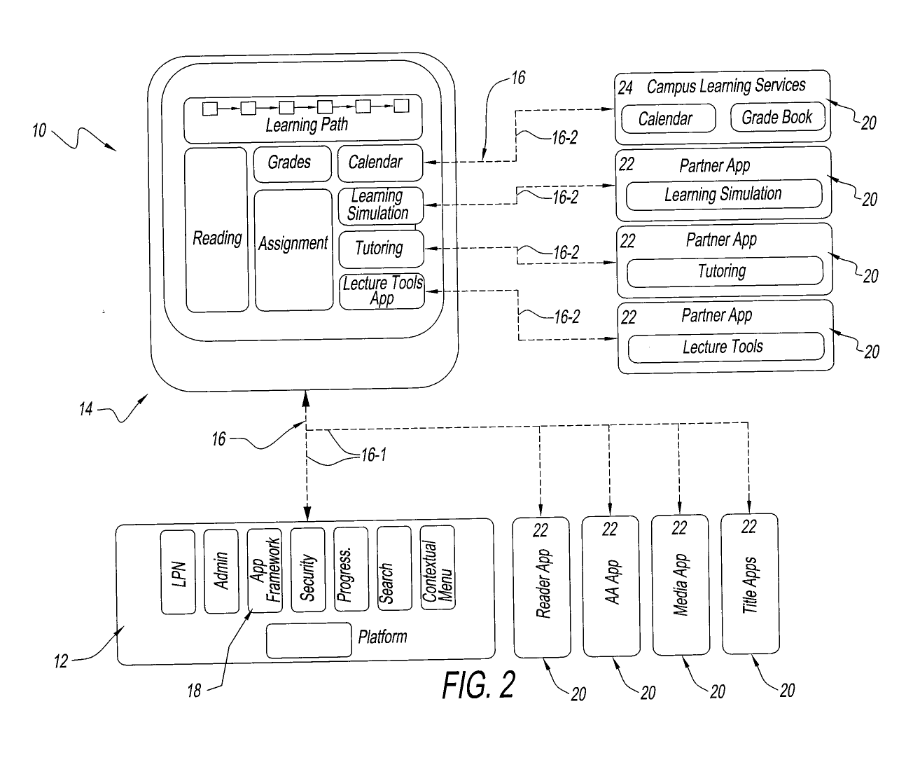

Referring to the drawings and in particular to FIGS. 1 and 2, a schematic depiction of an exemplary embodiment of a learning content delivery system according to the present disclosure is shown and is generally referred to by reference numeral 10.

System 10 includes a platform 12 resident on a server 13 that allows one or more user devices 14 to access remotely stored learning content (not shown) via a network 16 such as the Internet, bus, local area network (LAN), wide area network (WAN) or others. User devices 14 can include any web enabled device such as, but not limited to, desktop computers, laptop computers, personal digital assistants (PDA's), tablet computers, smart phones, mobile phones, and others.

Communication between user devices 14 and network 16 can be a wired communication, a wireless communication, or any combination thereof. The wired or wireless communication can be any communication protocol sufficient to deliver the desired content to user device 14. For example, the wireless communication can be any wireless protocol such as, but not limited to, WiFi, Bluetooth, code division multiple access (CDMA), global system for mobile (GSM), and others.

Advantageously, the system 10 provides access to digital content that engage students through interactivity and offers instructors choice in content, platforms, devices and learning tools. Thus, system 10 is configured to give students access to their course materials on demand. Further, system 10 is configured to allow instructors to seamlessly deliver the appropriate content to the students when and where they need it including the ability to support offline learning activities.

At the heart of system 10 is platform 12, which includes an application framework 18 to coordinate access by user devices 14 to a plurality of content delivery applications 20

Framework 18 allows applications 20 to be deployed using a JavaScript Object Notation (JSON) deployment descriptor or any other format capable of serializing and transmitting structured data over a network connection such as extensible markup language (XML). Thus, framework 18 allows system 10 to deploy applications 20 in a purely web-based manner so that no application code is deployed to platform 12.

Applications 20 can include platform specific or native applications 22 or generic or partner developed content delivery applications 24, and any combinations thereof. Platform specific applications 22 are developed on a common application programming interface (API), while generic applications 24 can be developed on any available API. Thus, platform 12 allows the student and teacher to access content from any available source, namely applications 22 specifically developed for the platform, as well as those developed for other systems.

Additionally, the platform specific applications 22 are resident on or in communication via network 16 the server 13 on which platform 12 resides, while generic content delivery applications 24 can reside on server 13 or any non-platform server. In the illustrated embodiment, platform specific applications 22 are either resident on server 13 on which platform 12 resides or in communication with the server via a LAN network connection 16-1. Conversely, generic content delivery applications 24 are in communication with server 13 on which platform 12 resides via an internet connection 16-2.

Platform 12 is configured to dynamically sense one or more attributes of user device 14 and to customize the presentation of content from platform specific applications 22 for that device. For example, platform 12 can determine the display size constraints of user device 14 and dynamically dictates single stacked or multiple tiled presentation of content from applications 22 on the device.

Platform specific applications 22 allow content providers to integrate their content for delivery on platform 12. Applications 22 provide notifications to platform 12 so that the platform is aware of each platform specific application available to the platform. Moreover, platform 22 provides notifications to all platform specific applications 22 on the platform so that the applications are aware of one another. Thus, system 10 provides two-way awareness between platform 12 and applications 22 so that the platform is aware of what applications are available as a content resource and so that each application is aware of what applications are available as a content resource.

Unlike other products that are affiliated with a single learning management system and can only access content from affiliated partners, system 10 provides, via platform 12, the ability to access not only affiliated content partners in an enhanced manner via platform specific applications 22, but to also access non-affiliated content provides via generic applications 24.

Platform specific applications 22 are hosted web applications such as regular web applications, but further include notifications, such as metadata that is communicated to platform 12. The metadata, in the form of a deployment descriptor allows platform specification applications 22 to be deployed to platform 12 such that there is no code deployed to the platform.

Platform 12 allows the entirety of the services and content from applications 20 to be carried out in a window that is launched on the user device 14. This includes any user interface and persistence required by the application 20. Platform specific applications communicate back to platform 12 at specific points during the workflow to keep the platform informed of the user's progress through the content.

Intercommunication between platform specific applications 22 and platform 12 is performed via raising and listening for a set of intrinsically defined platform as well as application custom defined events.

Intercommunication between platform specific applications 22 is also facilitated by the same event raise-listen capability. Each platform specific application 22 defines-registers their custom events via the deployment descriptor XML construct and the platform 12 can broker access to these event sets between peer platform specific applications 22 interested in intercommunication.

Platform 12 can provide any application instance upon launch, and/or via on-demand event based messaging, the learning context currently active. This enables the platform specific applications 22 to customize and optimize its functionality/interaction so as to provide the most fitting capabilities needed at any given point in time within a given learning context. For example, if a student is taking a quiz and performing poorly on the quiz or specifically with select questions/topics covered by the quiz, that learning context can be shared with a tutoring application 54 so as to recommend and/or match a learner with a particular live forum covering the topic in question, or possibly match the learner with a private tutor specialized on instruction in the topic needing remediation and improvement.

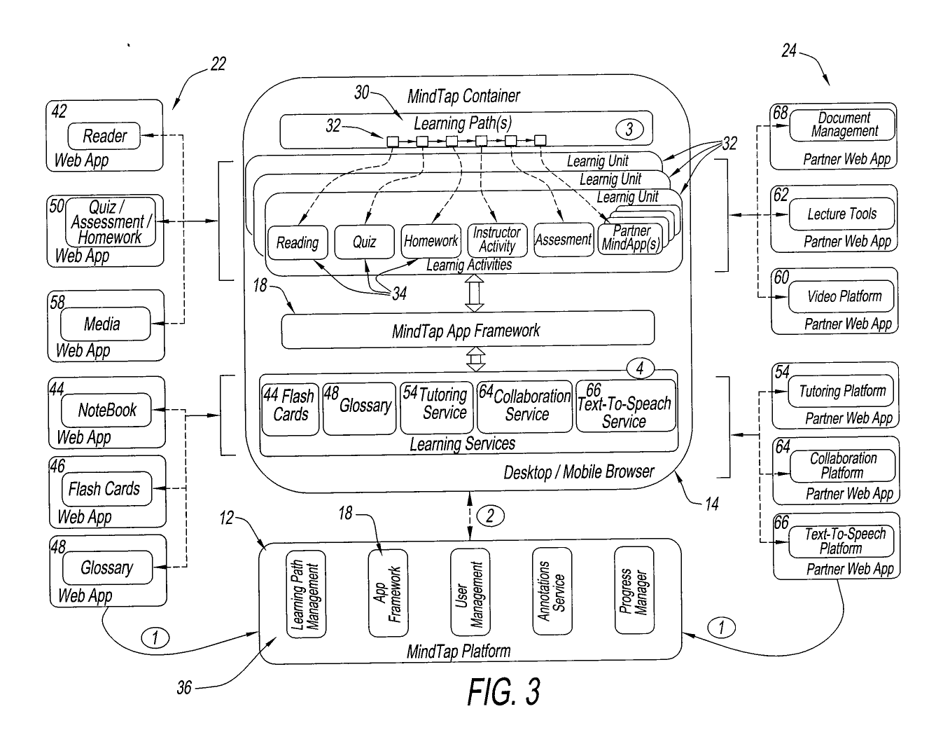

Referring now to FIG. 3, an exemplary embodiment of platform 12 will be described.

Platform 12 is organized to define a learning path 30, where the path is made up of a plurality of learning units 32 and each learning unit being made up of a number of specific learning activities 34. Each learning activity 34 is defined by content available from applications 20.

As discussed above, platform 12 is aware of all of the applications 20 that make up the learning activities so that system 10 can track a user's progress through the content that makes up each activity 34 and unit 32 along the learning path 30.

Accordingly, platform 12 allows a user or student to navigate along learning path 30, through each unit 32, which is a customized dashboard of activities 34 such as, but not limited to reading of document or text, assignments, videos, tests, quizzes, labs, hands on exercises, homework, and any other learning activity. Here, each activity 34 is accessed via applications 20 specifically configured for that activity.

In this manner, system 10 provides a powerful combination of personalized content and on-the-go access that encourages interactivity, increases student engagement, and is believed to improve learning outcomes. System 10 utilizes platform 12 to incorporate a variety of applications 20 that actively encourage students to interact with their course content, as well as their peers and instructors.

Within platform 12, instructors can track each student's progress along the learning path 30, within each learning unit 32, and for each learning activity in real-time, which provides opportunities for early intervention to influence progress and outcomes. Grades for various activities 34 and units 32 within the path 30 are visible and archived so students and instructors always have access to current standings in the class.

System 10 also allows instructors to customize the curriculum—via modification of the learning path 30, the learning units 32, and the activities 34 in each unit.

Framework 18 provides access to common services, provided by the applications 20, by facilitating inter-application communication and launch. Accordingly, framework 18 allows applications 20 to be enhanced with additional features during use by a student. For example, a student can launch into a tutoring session application 20, while working on a specific learning activity 34. Similarly, framework 18 allows an instructor can launch into a completed quiz while viewing a progress application 52 for a particular student.

In sum, each learning activity 34 is delivered to the student by the providing content via an application 20 specific for delivering that content. Here, framework 18 orchestrates workflows so as to allow the applications 20 to launch, deliver the desired learning content, and pass back a score to platform 12 as an event. The framework 18 also routes the prior events to interested applications 20, such as routing a score to the progress application 52.

In some embodiments, platform 12 can further include a learning path navigator 26, which uses framework 18 to orchestrate and deliver certain learning activities 34 to the students.

Learning path 30 is a definition, sequencing and orchestration of a personalized instruction, configured and customized by the instructor to fit a particular class or student's learning experience. The learning path 30 is a sequence of flexible of learning units 32 that contain underlying grouped/ungrouped collections of discrete learning activities 34.

Certain learning activities 34, and in some instances learning units 32 themselves, can be modified based on the students successful or unsuccessful progress through the learning path 30. The modification can be increase in new learning activities 34 when a student is struggling in a particular area. The modification can be a reordering of the activities 34 or the removal of activities based on a student's aptitude or success in a particular area. System 10 can be configured to automatically modify units and activities 32, 34 or to allow an instructor to manually modify the units and activities.

The learning activities 34 are applications 20 that deliver specific content and/or interactive learning tasks that, in some instances, can be measured or graded.

The functionality of certain platform specific applications 24 is described with reference to FIG. 3.

For example, system 10 includes reader application 42, which is a new interactive platform that brings digital textbooks to life. Reader 42 adds significant reading learning activity functionality embedded within the context of text and other elements including video/audio, annotations, activities, applications and instructor source materials.

Reader 42 is an e-book application that allows the user to read textual content. Advantageously, platform 12 includes an annotation service 56 that, via platform 12, allows the user to save notes into other applications 22 such as notebook application 44 and/or flashcard application 46 for later retrieval.

Advantageously, annotation service 56 that enables the connective referential linkage across all learning activity and service application content and data from all of the applications in communication with platform 12.

Reader 42 further allows the user to temporarily leave the textual content within the reader application to look up certain information in a glossary or dictionary application 48.

System 10 can include an assessment application 50 that allows for interactive homework, quizzes, and assessments to enable capture of a learner response to the units 32 and activities. Assessment application 50 can auto-score, as well as enable manual scoring where applicable.

The notebook application 44 aggregates all the personalized annotations 56 made by the learner and/or instructor compiled from the reader application 42 highlighting and contextualized page oriented note taking. In this manner, system 10 allows the student to easily store, find, filter and link back to the instance of the annotation made in its original context so as to facilitate learner reference, review and study tasks.

Similarly, the flashcard application 46 aggregates content elements that were tagged in reader application 42 into flash-card ready form and delivered for remediation usage.

The glossary application 48 delivers an aggregated collection, alphabetically as well as with other filtered views, of all the key terms defined throughout the reader application 42 and other learning activity content.

The progress application 52 aggregates all the curriculum measurement for the instructor's participating roster of learners, as well as a learner's individualized view of their measured performance in the curriculum, at any given time while the curriculum is actively engaged. Dimensions of measurement can include one or more of auto-graded, manually graded scores, and rubric based learning objective qualitative scoring on learning activities 34, engagement tracking metering/metrics measuring multiple elements of usage of the learning activities and underlying content elements outcomes-analytics (OA) measurements to provide metrics on performance against the learning path 30 curriculum goals mapped to underlying learning activity associated and measured (via rubrics) learning objectives.

For purposes of distinction, system 10 includes certain functionality or service applications such as, but not limited to notebook 44, flash cards 46, glossary 48, and tutoring platform 54. Additionally, system 10 includes certain learning applications, namely those represented by learning activities 34. The distinction is simply that the learning activity applications are specifically associated with a learning activity on a learning plan and typically assigned and measured via some scoring/grading and/or a qualitative rubric representing learning objective(s) mapped and measured for the learning activity. The functionality or service application is another form of application that is typically not associated with an learning activity or learning path and instead offers some tangential functionality to assist with or enhance the learning activities or experience overall (e.g. communication/collaboration tools, tutoring services, lecture capture tools etc.).

System 10 can include a media application 58, which is a native platform application, that delivers all video, audio, images/image gallery content elements a learning activity or embedded within content delivered by reader application 42. All content format types across multiple delivery device environments are supported and in cases automatically optimized for the target delivery environment.

System 10 can include a video application 60 that manage and deliver video content residing a cloud based repository that can then be utilized as a learning activity or component thereof within a learning path or embedded within content delivered by reader application 42.

System 10 can lecture tools 62 that, similar to video application 60, enable the creation/management of a collection of user lecture content assets that are represented by an aggregated video, audio and/or synchronized content feed of slides, document pages, images etc all used collective to convey an instructional lecture within the context of a learning path or embedded within content delivered by reader application 42.

System 10 can include a collaboration service application 64 that enables an online collaboration session of groups of users engaging with a synchronous delivery of one or more content elements such as video, audio, whiteboard and instant messaging.

System 10 can include a text-to-speech application 66 that enables reader application 42 or other learning activity text-based content elements to be selected by the user and read-aloud to that user via the user device 14.

System 10 can include a document management application 68 that enables document type content element collection created/managed by a user, such as a teacher, to be selected and delivered either as a learning activity on the learning path or embedded within content delivered by reader application 42.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated.

What is claimed is:

1. A learning content delivery system, comprising:
a network;
a plurality of remotely stored content delivery applications each comprising learning content;
one or more user devices; and
a platform, residing on a server, comprising an application framework, the application framework being configured to allow the one or more user devices to access the remotely stored applications and learning content via the network.

2. The learning content delivery system of claim 1, wherein the one or more user devices comprises a web enabled device.

3. The learning content delivery system of claim 1, wherein the one or more user devices comprise a device selected from the group consisting of a desktop computer, a laptop computer, a personal digital assistants, a tablet computer, a smart phone, a mobile phone, and any combinations thereof.

4. The learning content delivery system of claim 1, wherein communication between the one or more user devices and the network is wired communication, wireless communication, or any combination thereof.

5. The learning content delivery system of claim 1, wherein the applications comprise at least one generic application.

6. The learning content delivery system of claim 1, wherein the applications comprise at least two platform specific applications.

7. The learning content delivery system of claim 6, wherein the least two platform specific applications are developed on a common application programming interface.

8. The learning content delivery system of claim 6, wherein the platform is configured to dynamically sense one or more attributes of each user device and to customize presentation of the learning content from the platform specific applications for the user device.

9. The learning content delivery system of claim 6, wherein the application framework is configured to provide two-way awareness between the platform and the platform specific applications.

10. The learning content delivery system of claim 1, further comprising a plurality of remotely stored functionality applications, the application framework being configured to allow the one or more user devices to access the remotely stored functionality applications via the network.

11. A method of delivering learning content, comprising:
providing a plurality of learning content delivery applications;
organizing a learning path made up of a plurality of discrete learning units, each learning unit comprising a plurality of learning activities, wherein each learning activity is defined by learning content available from a different one of the plurality of content delivery applications; and
delivering, via a network, the learning content to a user device in an order defined by the learning units and learning path.

12. The method of delivering learning content of claim 11, wherein the step of providing the plurality of content delivery applications further comprises providing at least two platform specific applications developed on a common application programming interface.

13. The method of delivering learning content of claim 12, further comprising dynamically sensing one or more attributes of the user device and automatically customizing presentation of the learning content from the platform specific applications for the user device.

14. The method of delivering learning content of claim 12, further comprising providing two-way awareness between the at least two platform specific applications.

15. The method of delivering learning content of claim 12, wherein the step of delivering, via the network, the learning content to the user device comprises wirelessly delivery or wired delivery.

16. A learning content delivery system, comprising:
a network;
a user device in communication with the network;
a plurality of remotely stored learning activity applications, each of the plurality of learning activity applications comprising learning content;
a measurement application residing on a server; and
a platform, residing on the server, the platform comprising an application framework configured to allow the user device to access the plurality of learning activity applications and learning content via the network, the application framework providing awareness among the platform, the plurality of learning activity applications, and the measurement application so that the measurement application measures one or more attributes of a user's interaction with the plurality of learning activity applications and the learning content, the platform being configured to adjust a learning path through the plurality of remotely stored learning activity applications based on the one or more attributes.

17. The learning content delivery system of claim 16, wherein the platform is configured to allow the user to design the learning path using the application framework and the plurality of learning activity applications.

18. The learning content delivery system of claim 16, wherein at least one of the plurality of learning activity applications is on the server.

19. The learning content delivery system of claim 16, further comprising a learning content reader application comprising at least one learning activity application embed therein.

20. The learning content delivery system of claim 16, further comprising an annotation service that enables a connective referential linkage across all learning activity and service application content and data.
